(19) United States
(12) Patent Application Publication
(10) Pub. No.: US 2011/0059325 A1
(43) Pub. Date: Mar. 10, 2011

(54) CUT AND ABRASION RESISTANT WEBBING AND METHOD OF MANUFACTURING SAME

(75) Inventors: Ponsa Argemi Juan, Guangdong Province (CN); Ponsa Bosch Juan, Guangdong Province (CN)

(73) Assignee: Dongguan Ponsa Textitle Limited, Guangdong Province (CN)

(21) Appl. No.: 12/554,931

(22) Filed: Sep. 7, 2009

(51) Int. Cl. B32B 27/08; B32B 27/36; B32B 27/34; B32B 27/00; B32B 27/30; B32B 15/08; B05D 3/02; B32B 37/00; B32B 27/32

(52) U.S. Cl. 428/458; 428/480; 428/474.4; 428/516; 428/500; 428/461; 427/393.5; 156/280

(57) ABSTRACT

A cut and abrasion resistant webbing includes a main body (1) and a cut and abrasion resistant protection (3) attached over the main body. The main body is made from a high tenacity fiber, and the protection is made from a plastisol mixture forming a paste. A method of manufacturing the webbing includes steps of: applying the main body by weaving or not weaving fiber; and coating a cut and abrasion resistant paste onto the main body, then curing and drying, finally forming a cut and abrasion resistant protection on the surface of the webbing. The anti cut and anti abrasion webbing for lifting, sling, lashing, tie down and lanyard becomes very tough to abrasion and cut. And the life cycle thereof can be improved over 2 to 10 times than the actual manufactured ones.

### BACKGROUND OF THE INVENTION

The present invention relates to general safety equipments for lifting, sling, tie down, or lashing straps, tapes, or lanyards for any use, and especially to a cut and abrasion resistant webbing and method of manufacturing the webbing.

Actually the existing technology uses sleeve or jacket protection on the webbings of products such as lifting, sling, tie down or lashing lanyard, to protect them from abrasion or cut. For example, U.S. Pat. No. 4,886,691 shows a cut resistant article, which comprises a cut resistant jacket surrounding a less cut resistant member. The jacket comprises a fabric of yarn, and the yarn consisted of a high strength, longitudinal strand wrapped with another fiber or the same fiber. Other conventional sleeve or jacket is also made in rubber, plastic, or textile clothes. Sleeve is attached over the final product and fixed using a stitching machine, by inserting a tubular or round sleeve, or mould forming. However, the existing technology referred as using sleeve or jacket protectors, is not cost effective since it requires various additional steps and materials, and quality and effectiveness of anti cut is in a low profile. Furthermore, it is very easy to unbound and not precisely positioned, what could possibly cause the looseness of tension and the loss of the cargo during transportation applications or for lifting applications manipulating the cargo, if sleeve is not perfectly positioned.

Other conventional method to improve the cut and abrasion resistance of the webbing, as shown in U.S. Pat. No. 5,419,951, provided a protective warp yarn structure made up of bicomponent fibers. The bicomponent fibers include a polyester core with a sheath of a polymer with a lower melting point than the polyester. Herein the webbing has been subjected to a heat treatment sufficient to cause melting of said sheath, but not of the core. However, it is not always effective to improve the cut and abrasion resistance using such modified warp yarns to weave into the webbing. Furthermore, it is a costly and complex process to obtain the bicomponet fibers.

Therefore, an improved webbing and a method of manufacturing of the same is desired which overcomes the disadvantages of the prior art.

### BRIEF SUMMARY OF THE INVENTION

A main object of the present invention is to provide a cut and abrasion resistant webbing or webbing assembly, which can become very tough to abrasion and cut in use, improve the life cycle 2-10 times, and supply a much safer use.

A further object of the present invention is to provide a method to manufacture the webbing, which is more effective, simpler, reliable, and cost-effective.

To obtain the above object, a cut and abrasion resistant webbing comprises a main body and a cut and abrasion resistant protection attached over the main body. The main body is an elongated strap or sheet made from high tenacity fiber, and the protection is made from a plastisol mixture forming a paste.

A material for the main body is chosen from high tenacity synthetic polyester, polypropylene, polyamides, polyethylene high modulus, Kevlar, or polyethersulfone. The protection is made from a paste of a mixture of a plastisol with a curing agent, such as isocyanate or the like.

The plastisol is a dispersion of a base resin and additives in a plasticizer that forms a liquid compound, the base resin of the plastisol is selected from: vinyl resin, acrylic resin, methyl methacrylate copolymers, and styrene copolymers, or the like. The plasticizer comprises phthalates; epoxides; aliphatic dicarboxylic acid esters; phosphates; polyesters; hydrocarbons, chlorinated hydrocarbons; esters of terephthalic acid, trimellitic acid, pyromellitic acid, citric acid and the alkyl sulfonic acid esters of phenol and cresol; or the like.

The webbing further comprises an interlayer inserting between the main body and the protection, which is made from high tenacity synthetic polyester, polypropylene, polyamides, polyethylene high modulus, Kevlar, UHMWPE (Dyneema) or polyethersulfone, or the like.

A webbing assembly comprises a cut and abrasion resistant webbing with or without combining plastic or metal parts, wherein the cut and abrasion resistant webbing comprises a webbing body with a cut and abrasion resistant protection imbedded on a surface thereof, and the protection is made from a plastisol mixture forming a paste.

The webbing body is made of high tenacity fiber as an elongated strap or straps in a laminated structure.

A method of manufacturing a webbing comprises steps of:

(1) providing a main body made from high tenacity fibers;

(2) preparing an anti cut and anti abrasion chemically composed paste made of a plastisol; and

(3) coating the main body with the plastisol paste, and later drying and curing to exact texture, hardness and flexibility, thereby the webbing is formed with a cut and abrasion resistant protection imbedded on a surface thereof.

The method further comprises a step between the step (2) and step (3) of: bounding of an interlayer of webbing material onto the main body before coating the paste onto the main body at step (3).

At the step (2) the anti cut and anti abrasion chemically composed paste is made of a mixture of vinyl plastisol with isocyanate.

The drying temperature is at a range of 90 to 300 degrees Celsius, and a curing temperature is at a range of 60 to 200 degrees Celsius at the final step.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is an exploded view of a laminated structure of a webbing in accordance with an embodiment of the present invention;

FIG. 2 is an exploded view of a laminated structure of a webbing in accordance with another embodiment of the present invention;

FIG. 3 is a perspective view of a webbing assembly with an embodiment of the present invention;

FIG. 4 is a perspective view of a webbing assembly with another embodiment of the present invention;

FIG. 5 is a perspective view of a webbing assembly with the third embodiment of the present invention; and

FIG. 6 is a perspective view of a webbing assembly with the fourth embodiment of the present invention.

### DETAILED DESCRIPTION OF THE INVENTION

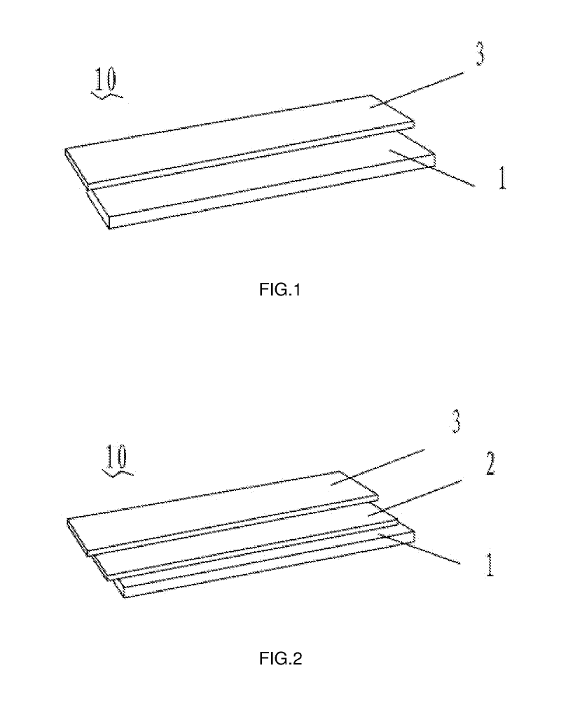

FIG. 1 shows a laminated structure of a webbing 10 of the present invention. Such laminated structure of the webbing 10 includes a main body 1, and a cut and abrasion resistant protection 3. Herein, the cut and abrasion resistant protection 3 is coated on a surface of the main body 1.

The main body 1 generally is an elongated flexible band, strip, strap, lanyard or tape of woven textile material. Textile materials for the main body 1 can be chosen from: high tenacity synthetic polyester, polypropylene, Nylon or polyamides, polyethylene high modulus, Kevlar, ballistic nylon, ballistic PES (Polyethersulfone), ballistic polypropylene, or other synthetic fiber in the art, with one or more combined together. It is understood that the main body 1 of the invention may also be applicable to non-woven strips or a sheet of the textile material. It is preferred that the webbing is manufactured using at least one fiber chosen from high tenacity yarns, such as polyester, polypropylene, Nylon, Kevlar and polyethylene high Modulus yarns. Any other fiber the market could offer is applicable, too.

The cut and abrasion resistant protection 3 is made from an anti cut and anti abrasion chemically composed paste of a plastisol mixture.

A thin webbing interlayer 2 is inserted between the main body 1 and the cut and abrasion resistant protection 3 in another embodiment, referring to FIG. 2. The interlayer 2 may be a woven strap, band, or tape, and may also be a non-woven strap or sheet. Materials for the interlayer 2 may be chosen from high tenacity Synthetic Polyester, Polypropylene, Nylon or Polyamides, Polyethylene high modulus, Kevlar, ballistic nylon, ballistic PES, ballistic polypropylene, UHMWPE (Dyneema), or other synthetic fiber in the art, with one or more combined together. The interlayer 2 can also be made from various materials in the art in order to reinforce the webbing.

A method of manufacturing the webbing in the present invention comprises steps of:

(1) providing a main body 1 with fibers being braided, knitted, woven or otherwise made into fabric or sheet;

(2) preparing an anti cut and anti abrasion chemically composed paste made of a plastisol; and

(3) coating the main body 1 with the plastisol paste, and later dried and cured to exact texture, hardness and flexibility.

Therefore, a final appearance and shape of the product is a well formed, and a flexible layer attached over the webbing. The method of the present invention imbeds directly the anti cut protection 3 on the surface of the webbing 10, so that an effective protection from cut and abrasion is performed, and the process is relatively simple, convenient, and cost effective. The final anti cut and anti abrasion resistant webbing for lifting, sling, lashing, tie down or lanyard becomes very tough to abrasion and cut.

It is understood that this anti cut protection 3 is added either when the manufacturing of the webbing or tape takes place or after in another process.

According to another embodiment of the present invention, the method of manufacturing the webbing comprises a further step: before being coated as well with the same chemically composed paste onto the surface of the main body 1, but inserting another thin webbing interlayer 2 therebetween. In other words, the method includes the steps of:

(1) manufacturing of the webbing or webbings main body 1 with or without weaving looms;

(2) preparing an anti cut and anti abrasion chemically composed paste made of a plastisol mixture;

(3) bounding of the interlayer 2 of webbing material onto the main body 1; and

(4) coating the main body 1 with the plastisol paste, and later dried and cured to exact texture, hardness and flexibility.

Therefore, the final webbing is well reinforced by the interlayer 2 therein with high tenacity, and a flexible protection 3 with anti cut and abrasion property is imbedded on the surface of the webbing with a reinforced layer 2 therebetween.

According to the step (2), the plastisol generally is a dispersion of a base resin and additives in a plasticizing liquid that forms a liquid compound. When heated, the plastisol fuses into a tough functional coating providing properties such as abrasion, corrosion and electrical resistance. The base resin of the plastisol may be selected from, but not limited to, vinyl resin, acrylic resin, methyl methacrylate copolymers, styrene copolymers, or the like. The plasticizer comprises such as phthalates; epoxides; aliphatic dicarboxylic acid esters; phosphates; polyesters; hydrocarbons, chlorinated hydrocarbons; esters of terephthalic acid, trimellitic acid, pyromellitic acid, citric acid and the alkyl sulfonic acid esters of phenol and cresol; or the like. Additives such as a diluent or a thermal stabilizer may also be used. The chemically composed paste may further comprise a curing agent, such as isocyanate.

A detailed description of the vinyl plastisol and the acrylic plastisol is as follows. The vinyl plastisol is formed by mixing a vinylchloride-based resin with a plasticizer and additives, where the plastisol base selected from vinyl chloride homopolymers or vinyl chloride copolymers. The plasticizer used in the preparation of the vinyl plastisol may be di(2-ethylhexyl)phthalate, dibutylphthalate, butyl benzyl phthalate, diisobutyl adipate, heptyl nonyl adipate, an epoxy derivative such as bis-(2-ethylhexyl)adipate epoxylated soybean oil, tributyl phosphate, butyl cyclohexyl phthalate, or the like.

The acrylic plastisol consists of a plasticizer having acrylic resin particles dispersed therein. Examples of acrylic resin particles in the present invention include, for example, a homopolymer or copolymer of alkyl acrylate ester (wherein alkyl is methyl, ethyl, butyl, 2-ethylhexyl, etc.) or alkyl methacrylate ester (wherein alkyl is methyl, ethyl, butyl, lauryl, stearyl, etc.), or another copolymer with other acrylic monomer (e.g., methacrylic acid, acrylic acid etc.) or itaconic acid. Examples of plasticizer in the present invention include, for example, phthalate ester such as di-2-ethylhexyl phthalate, butyl benzyl phthalate, dinonyl phthalate, diisononyl phthalate, diisodecyl phthalate, diundecyl phthalate, diheptyl phthalate, butyl phthalyl butyl glycolate; aliphatic dibasic acid ester such as dioctyl adipate, didecyl adipate, dioctyl sebacate; polyglycol benzoate such as polyoxyethylene glycol dibenzoate, polyoxypropylene glycol dibenzoate; trimellitate; pyromellitic acid ester; phosphates such as tributyl phosphate, tricresyl phosphate; hydrocarbons such as alkyl-substituted diphenyl, alkyl-substituted terphenyl, partially hydrogenated alkyl terphenyl, aromatic process oil, pine oil, and the like.

The process of drying and curing is not particularly limited. The temperature for drying is adjusted to 90 to 300 degrees Celsius. Most plastisols for the protection 3 need to reach a temperature at a range of 60-200 degrees Celsius, and preferably of about 160 degrees Celsius (350 Fahrenheit) for full curing.

The final webbing product, being manufactured according to the above method using described materials, becomes very tough to abrasion and cut in use.

In a contrast experiment for lifting logs, we use a webbing with a cut and abrasion resistant protect 3 thereon of the present invention, and one actual manufactured in the art without a cut and abrasion resistant protection 3 thereon, to respectively lift a log under the same circumstance. The result shows that a life cycle of the webbing of the present invention is over 2 to 10 times than the actual manufactured ones depending on the surface treatment used or requested.

A webbing assembly of the present invention can be widely used as a general safety equipment for lifting, sling, tie down, or lashing. Industrial applications refers to any where involved a lifting, pulling or towing, and includes as well those for transportation applications such as Vessels, ship Carriers, ro-ro vessels, military vessels or ships, planes commercial carriers or military carriers, Trucks, Cars, SUV (sport utility vehicle), motorbikes or any other possible, for industrial, commercial, military or aerospace applications.

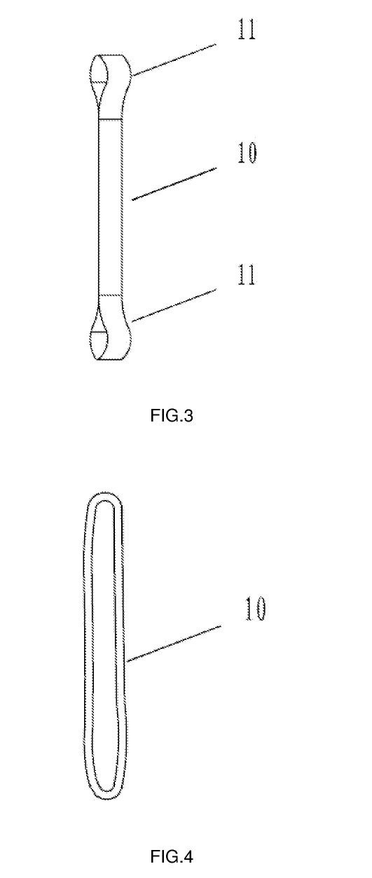

For instance, the webbing assembly is used for a lifting sling, including any type of sling, such as round sling, endless sling, one way sling, webbing sling, tubular slings, eye to eye slings, double band sling, single band sling, flat sling, tree trunk sling or any other type of sling used for lifting, pulling or towing of heavy weight goods for industrial, commercial, military and aerospace applications, with or without a combination of any other part. Herein, the part may be manufactured with any possible material like plastic or metal, such as buckles, winch, hooks, rings or any other rigging component. Referring to FIG. 3, the webbing sling 10 is used to hold a load of logs (not shown), is an elongated strap with eyes 11 formed at opposite ends thereof. The eyes 11 are formed by folding the sling 10 back on itself and stitching the free end to the bight of the sling 10. FIG. 4 shows a round sling or a tubular sling 10 also used for lifting, pulling or lashing applications.

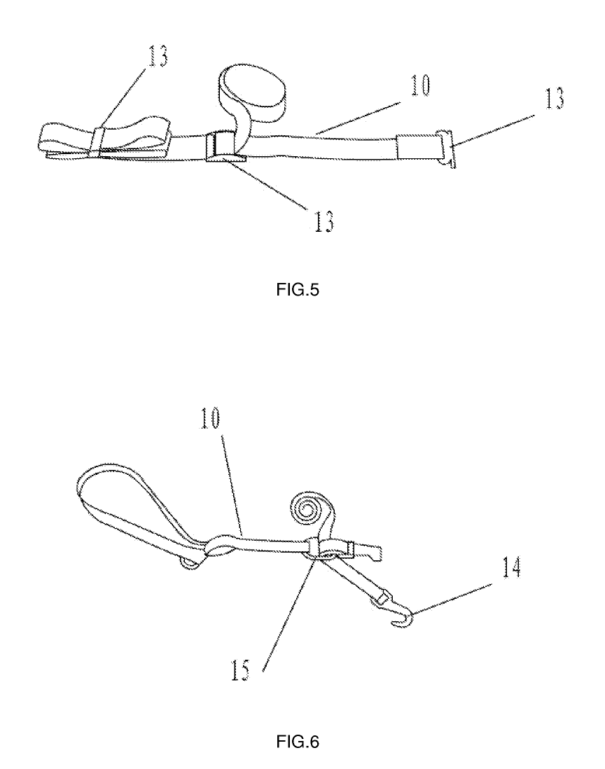

For tie down and lashing strap applications, the webbing is widely used as ratchet tie down in any form, cam buckle tie down in any form, winch tie down in any form, truck lashings in any form, car lashing in any form, lashing tapes in any form, lashing webbings in any form or any other type of lashing system that might be able to use this type of lashing tie down webbing or tape. The webbing is used with or without the combination of any other parts. The parts may be manufactured with any possible material like plastic or metal, such as buckles, winch, hooks, rings, cam buckles or any other rigging component. FIG. 5 shows a webbing assembly for lashing or tie down applications, wherein the anti cut and anti abrasion webbing 10 is used with a combination of a plurality of metal buckles 13 for securing both the webbing and the load (not labeled). FIG. 6 shows a kind of lashing sling assembly, which includes a webbing 10 and a plurality of parts such as hook 14 and ring 15.

What is claimed is:

1. A cut and abrasion resistant webbing comprising:
a main body; and
a cut and abrasion resistant protection attached over said main body;
wherein said main body is an elongated strap or sheet made from high tenacity fiber, and said protection is made from a plastisol mixture forming a paste.

2. The webbing according to claim 1, wherein a material for said main body is chosen from high tenacity synthetic polyester, polypropylene, polyamides, polyethylene high modulus, Kevlar, or polyethersulfone.

3. The webbing according to claim 1, wherein said protection is made from a paste of a mixture of a plastisol with a curing agent.

4. The webbing according to claim 3, wherein said curing agent is isocyanate.

5. The webbing according to claim 1, wherein said plastisol is a dispersion of a base resin and additives in a plasticizer that forms a liquid compound, the base resin of the plastisol is selected from: vinyl resin, acrylic resin, methyl methacrylate copolymers, and styrene copolymers.

6. The webbing according to claim 5, wherein said plasticizer comprises phthalates; epoxides; aliphatic dicarboxylic acid esters; phosphates; polyesters; hydrocarbons, chlorinated hydrocarbons; esters of terephthalic acid, trimellitic acid, pyromellitic acid, citric acid and the alkyl sulfonic acid esters of phenol and cresol.

7. The webbing according to claim 6, wherein a vinyl plastisol is formed by mixing a vinyl resin with a plasticizer and additives, where the vinyl resin is selected from vinyl chloride homopolymers and vinyl chloride copolymers, the plasticizer is selected from di(2-ethylhexyl)phthalate, dibutylphthalate, butyl benzyl phthalate, diisobutyl adipate, heptyl nonyl adipate, an epoxy derivative, tributyl phosphate, and butyl cyclohexyl phthalate.

8. The webbing according to claim 6, wherein an acrylic plastisol comprises a plasticizer having acrylic resin particles dispersed therein, where acrylic resin particles is selected from a homopolymer or copolymer of alkyl acrylate ester or alkyl methacrylate ester, or copolymer of methacrylic acid, acrylic acid or itaconic acid; the plasticizer is selected from: di-2-ethylhexyl phthalate, butyl benzyl phthalate, dinonyl phthalate, diisononyl phthalate, diisodecyl phthalate, diundecyl phthalate, diheptyl phthalate, butyl phthalyl butyl glycolate, dioctyl adipate, didecyl adipate, dioctyl sebacate, polyoxyethylene glycol dibenzoate, polyoxypropylene glycol dibenzoate, trimellitate, pyromellitic acid ester, tributyl phosphate, tricresyl phosphate, alkyl-substituted diphenyl, alkyl-substituted terphenyl, partially hydrogenated alkyl terphenyl, aromatic process oil, and pine oil.

9. The webbing according to claim 1, wherein said webbing further comprises an interlayer inserting between said main body and said protection.

10. The webbing according to claim 9, wherein said interlayer is made from synthetic polyester, polypropylene, polyamides, polyethylene or UHMWPE, Kevlar, or polyethersulfone.

11. A webbing assembly comprising
a cut and abrasion resistant webbing; and
parts engaged with said webbing;
wherein said cut and abrasion resistant webbing comprises a webbing body with a cut and abrasion resistant protection imbedded on a surface thereof, and said protection is made from a plastisol mixture forming a paste.

12. The webbing assembly according to claim 11, wherein said webbing body is made of high tenacity fiber as an elongated strap or straps in a laminated structure.

13. The webbing assembly according to claim 11, wherein said plastisol is a dispersion of a base resin and additives in a plasticizer that forms a liquid compound, the base resin of the plastisol is selected from: vinyl resin, acrylic resin, methyl methacrylate copolymers, and styrene copolymers.

14. The webbing assembly according to claim 11, wherein said parts is made from plastic or metal.

15. The webbing assembly according to claim 11, wherein said webbing assembly is used for a lifting sling, tiedown and lashing strap tapes or lanyards, the lifting sling includes round sling, endless sling, one way sling, webbing sling, tubular slings, eye to eye slings, double band sling, single band sling, flat sling, or tree trunk sling.

16. A method of manufacturing a webbing comprising steps of:
(1) providing a main body made from high tenacity fibers;
(2) preparing an anti cut and anti abrasion chemically composed paste made of a plastisol; and
(3) coating the main body with the plastisol paste, and later drying and curing, whereby the webbing is formed with a cut and abrasion resistant protection imbedded on a surface thereof.

17. The method according to claim 16, wherein the method further comprises a step of, between said step (2) and step (3): bounding of an interlayer of webbing material onto the main body before coating said paste onto said main body at step (3).

18. The method according to claim 16, wherein said plastisol is a dispersion of a base resin and additives in a plasticizer that forms a liquid compound, the base resin of the plastisol is selected from: vinyl resin, acrylic resin, methyl methacrylate copolymers, and styrene copolymers.

19. The method according to claim 18, wherein said paste is made of a mixture of vinyl plastisol with isocyanate.

20. The method according to claim 16, wherein said drying temperature is at a range of 90 to 300 degrees Celsius, and a curing temperature is at a range of 60 to 200 degrees Celsius.
